(19) United States
(12) Patent Application Publication
(10) Pub. No.: US 2007/0232110 A1
(43) Pub. Date: Oct. 4, 2007

(54) MULTI-STORY BUILDING CONNECTOR SYSTEM AND METHOD

(75) Inventor: John Rizzotto, Stuart, FL (US)

Correspondence Address: DICKSTEIN SHAPIRO LLP, 1177 AVENUE OF THE AMERICAS (6TH AVENUE), NEW YORK, NY, 10036-2714, US

(73) Assignee: John Rizzotto, Stuart, FL (US)

(21) Appl. No.: 11/680,475

(22) Filed: Feb. 28, 2007

Related U.S. Application Data
(60) Provisional application No. 60/777,554, filed on Mar. 1, 2006.

(51) Int. Cl. H01R 13/62

(52) U.S. Cl. 439/326

(57) ABSTRACT

A construction connector designed to fit column framework members to rapidly construct multi-story buildings is disclosed. In a preferred embodiment, the connector has an elongated main body with two holes at each end. A leveling plate attaches transversely to the body. An angle support member having two ten-gauge steel arms is welded to the bottom portion of the connector. A process for building the multi-story framework is also disclosed. The resulting structure has greatly improved resistance to uplift forces and seismic effects.

### FIELD OF THE INVENTION

The present invention relates to a construction connector for multi-story buildings that is designed to fit framework members which results in rapid, precise, and low-cost building assembly. The present invention also relates to a multi-story construction connector with a greatly improved resistance to uplift forces and seismic effects, and a method of constructing improved multi-story buildings with the same.

### BACKGROUND OF THE INVENTION

There are a number of prior art steel buildings containing features designed to facilitate assembly, as evidenced by the patents referenced below.

U.S. Pat. No. 4,342,177 illustrates a steel frame building in which the roof beams are connected to the columns by means of a plate using bolts. However, this attachment does not allow for height adjustment. The columns are C-shaped and cannot be easily slipped over a foundation assembly.

U.S. Pat. No. 5,577,353 illustrates a steel frame building in which the components of the trusses are held together with pre-drilled truss plates and bolts and the trusses are attached to the columns by means of pre-drilled plates and bolts. However, there is no provision for height adjustment at the column attachment. There is no provision to allow the trusses to be conveniently broken in two for transport and there is no provision to allow the columns to slip over the foundation members.

U.S. Pat. No. 5,979,119 illustrates an assembly of structural building components designed to be attached to a column. The attachment method permits the adjustment of the angle at which beams are connected however, height adjustment is achieved by clamping rather than positive bolting.

In prior art structures, the mounting system for columns was typically bolts placed in the concrete footer before the concrete had set. A column is connected to a flange and the flange is secured to a footer by means of bolts. The position of the bolts is usually determined by a steel tape measure, which usually results in location errors in the order of ¼ to ½ inch. These errors require the framing members to be cut and fitted on the site, a slow and costly process. The reason for these errors are many and include the use of a tape measure, the use of aggregate in the concrete which makes it difficult to precisely set a bolt in place and the fact that the bolt is let stand while the concrete sets up. During the set up process, the bolt can be moved by a variety of forces including the bolt's own weight, pent up pressure points created by forcing the bolt into the concrete, wind, rain and inadvertent contact by workmen.

In the prior art assembly procedure, once the concrete has set up and the bolts have been secured in the concrete, the next task is the lifting of the column over and onto these bolts. The column typically has a lower flange with holes used to accommodate the bolts and connect the column to the footing. The column with its flange is lowered down on to the bolts and nuts are used to secure the bolts to the flange. However, at this time, with the column suspended in the air, it is difficult to correct for the horizontal plane location errors of the bolts, while at the same time connect the column to the bolts and erect the column in a perfectly vertical position. This prior art assembly procedure does not lend itself to precisely locating the column and results in building members not fitting together and requiring time consuming and costly redrilling and cutting on the job. site to complete the assembly of the building.

Pending U.S. patent application Ser. No. 10/411,648 discloses a framing assembly system for steel buildings where foundations assemblies or anchor structures are located precisely before encasing the foundation structure in concrete. This application discloses that columns can be attached to the anchor structures at the foundation of a single story structure. FIG. 3 of pending U.S. patent application Ser No. 10/411,648, illustrated in the present application as FIG. 1, and the balance of that application's disclosure illustrate and disclose only a single story structure.

Thus, there is a need to create a multi-story building structure that can not only withstand the types of forces presented by hurricanes and earthquakes, but is also quick and inexpensive to assemble. All of the above mentioned disadvantages of the prior art are addressed and overcome in the present invention which is described below.

### BRIEF SUMMARY OF THE INVENTION

A construction connector designed to fit column framework members to rapidly construct multi-story buildings is disclosed. In a preferred embodiment, the connector has an elongated main body with two holes at each end. A leveling plate attaches transversely to the body. An angle support member having two ten-gauge steel arms is welded to the bottom portion of the connector. A process for building the multi-story framework is also disclosed. When used in conjunction with precisely located lower story column structural members, the resulting structure has greatly improved resistance to uplift forces and seismic effects. Such precisely located lower story column structural members are disclosed in U.S. patent application Ser. No. 10/411,648, incorporated by reference herein.

In one aspect, the present invention is directed to a construction connector comprising: an elongated main body having a longitudinal direction with two end portions; and an angle support member attached to one end of the elongated main body, the angle support member having one arm extending transversely to the longitudinal direction of the elongated main body;

In another aspect of the present invention, the construction connector further comprises a leveling plate attached transversely to the elongated main body.

In another aspect of the present invention, the elongated main body defines at least one aperture at one end.

In another aspect of the present invention, the angle support member is welded to the elongated main body.

In another aspect of the present invention, the angle support member is at least ten gauge thick.

In another aspect of the present invention, where each end of the elongated main body is configured and adapted for attachment to a construction column.

In another aspect of the present invention, the elongated main body has a rectangular cross-section.

In another aspect of the present invention, the elongated main body has a square cross-section.

In another aspect of the present invention, the connector is an integral member.

In another aspect of the present invention, one end of the elongated main body is encased in concrete.

In another aspect of the present invention, one end of the elongated main body is a stanchion over which a construction column may be placed.

In another aspect of the present invention, one end of the elongated main body is a collar into which a construction column may be inserted.

In another aspect of the present invention, the construction connector comprises: an elongated main body having a longitudinal direction with two end portions, each end portion defining two apertures; a leveling plate attached transversely to the elongated main body; and an angle support member attached to one end of the elongated main body, the angle support member has two arms extending transversely to the longitudinal direction of the elongated main body;

In another aspect of the present invention, a method of connecting multi-story structures for use in a building construction, comprising the steps of: positioning a bottom connecting portion of a connector structure over a column; sliding the connector structure over the column; and fastening the connector structure to the column;

In another aspect of the present invention, the method further comprises resting at least one angle support member of the connector structure on a wall panel.

In another aspect of the present invention, the method further comprises encasing at least part of the bottom connecting portion in concrete.

In another aspect of the present invention, the method further comprises aligning holes in a second column with holes in a column receiving portion of the connector structure.

In another aspect of the present invention, the method further comprises fastening a second column to a column receiving portion of the connector structure.

In another aspect of the present invention, the method further comprises pouring concrete to a height of a leveling plate attached to the connector structure.

### BRIEF DESCRIPTION OF THE DRAWINGS

For the purposes of illustrating the present invention, there is shown in the drawings a form which is presently preferred, it being understood however, that the invention is not limited to the precise form shown by the drawing in which:

FIG. 1 illustrates an example of a prior art single-story framework structure;

FIG. 2a is a detailed drawing illustrating a preferred embodiment construction connector;

FIG. 2b is a drawing illustrating an alternate embodiment of a construction connector;

FIG. 3 illustrates the integration of a construction connector in a multi-story building structural framework;

FIG. 4 is a diagram illustrating a side view of a building framework utilizing a preferred connector;

FIG. 5 is a diagram illustrating an alternative preferred embodiment construction connector that can be attached to support beams of an existing structure; and

FIG. 6 is a flow chart that illustrates a method of building a multi-story structure.

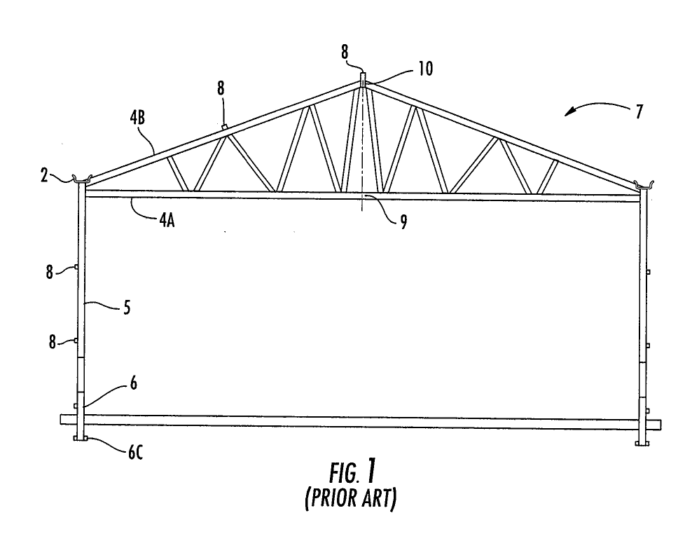

### DETAILED DESCRIPTION OF THE INVENTION

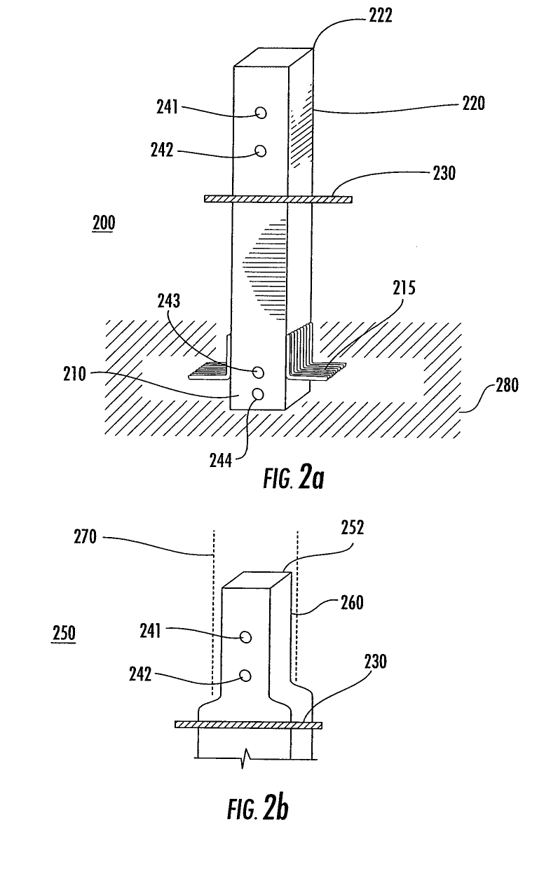

FIG. 2a illustrates a multi-story connector 200, comprising a bottom portion 210 and a column receiving portion 220. In one preferred embodiment, the column receiving portion may comprise a collar as illustrated in FIG. 2a, where the column is narrower than the column receiving portion, so that the column can slide in the receiving portion of the connector. The bottom portion 210 of connector 200 preferably has an angle support member 215. The angle support member 215 comprises welded ten (10) gauge angle pieces that allow connector 200 to rest upon a horizontal surface. Connector 200 may also comprise leveling plate 230 between bottom portion 210 and column receiving portion 220. Both ends of the connector define two or more apertures on each side, as indicated by reference nos. 241, 242, 243 and 244, as shown in FIG. 2a. It should be noted that the use of two or more apertures on both ends of the connector significantly increase the strength of the resultant structure, as concluded by tests conducted by the Space Alliance technology Outreach program (SATOP) in RTA #2044, incorporated by reference herein. Further, bottom portion 210 of connector 200 is preferably encased in concrete 280, for additional structural strength.

In another embodiment, illustrated in FIG. 2b, connector 250 comprises a column receiving portion 260 configured as a stanchion 252. As illustrated in FIG. 2b, a column 270 can be mated over column receiving portion 260. Connector 250 further comprises a leveling plate 230 dividing the connector. Like connector 200, both ends of connector 250 define two or more apertures on each side, as indicated by reference nos. 241 and 242, shown in FIG. 2b.

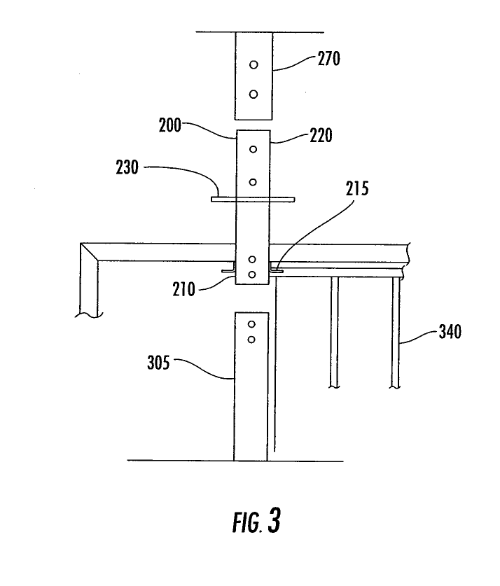

FIG. 3 illustrates the integration of a construction connector in a multi-story building structural framework As shown in FIG. 3, connector 200 is fixed in its precise and proper location in the building's structural framework. In one embodiment, illustrated in FIG. 3, construction column 305 is attached to the bottom portion 210 of connector 200 at the lower floor level. Construction column 270 is attached to column receiving portion 220 of connector 200 at the upper floor level. In a preferred embodiment, the columns 305 and 270 are 3 inch by 3 inch square steel tubes that are placed in stanchions 210, 220 connector 200 and attached using ½ inch by 5 inch carriage bolts. In a preferred embodiment, the 3 inch by 3 inch columns also have a ¾ inch furring strip attached (not shown). Angle member 215 rests on top of a wall frame header 340.

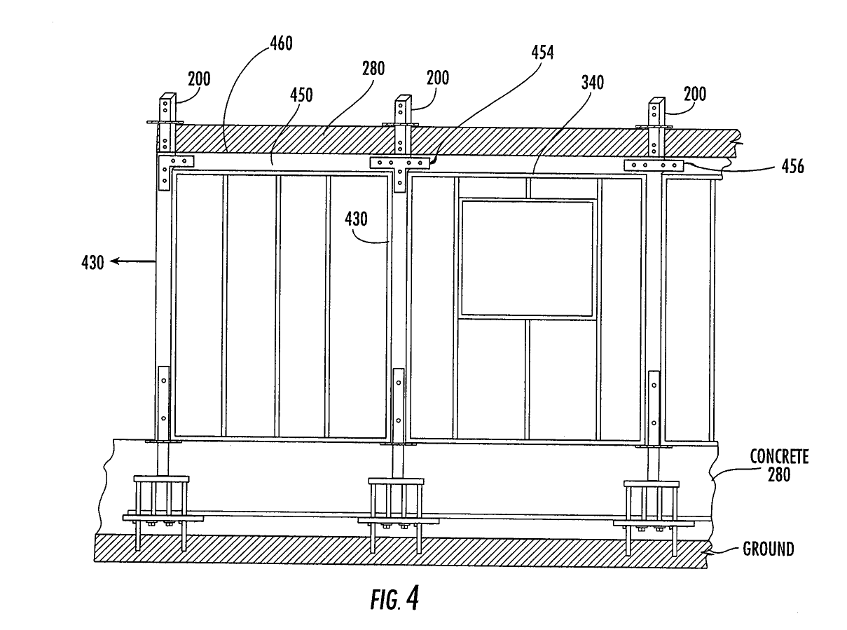

FIG. 4 is a side partial cross-sectional view of the framework of a first story of a structural framework built in accordance with the present invention. As shown in FIG. 4, wall panels 340 comprising a frame and studs that are placed in between and fastened to columns 430. In a preferred embodiment, wall panels 340 are 18 gauge 2 inch by 6 inch wall panels, which may be prefabricated off-site. The wall panels 340 are affixed to columns 430 with a ¾ inch offset by attaching ¾ inch furring to the columns 430, and then securing the wall panels 340 to the furring using self-tapping screws.

The top of each column 430 is linked to the tops of adjacent columns to form a header 450. Header 450 forms a continuous perimeter beam that connects all of the columns and wall portions together. In a preferred embodiment, 3 inch by 3 inch square steel tubing 450 is used, and is attached to columns 430 by T-strap connectors 454, flat strap connectors 456, or other similar connectors.

In a preferred embodiment, the height of the wall panels is slightly less than that of the columns, allowing the steel tubing 450 that forms the header to be attached to the sides of the columns 430. This allows the steel tubing 450 to be shorter in length, making them easier to handle. In a preferred embodiment, 18 gauge metal may also be used to attach the studs of adjacent wall panels 340 to each other and to the column 430.

The construction connectors 200 are attached to columns 430 as shown in FIG. 4. Epicor steel floor panels 460 are affixed to header steel tubing 450. Temporary batter boards (not illustrated) are placed surrounding the outside edges of the next floor of the structure, thereby creating a form within which concrete 280 can be poured. Once the connectors 200 have set in concrete 280,wall and framework members can be prepared for this next story in the building framework. Subsequent floors may also be installed using the connectors, as long as all the loads and strengths are checked by the design engineer per applicable codes.

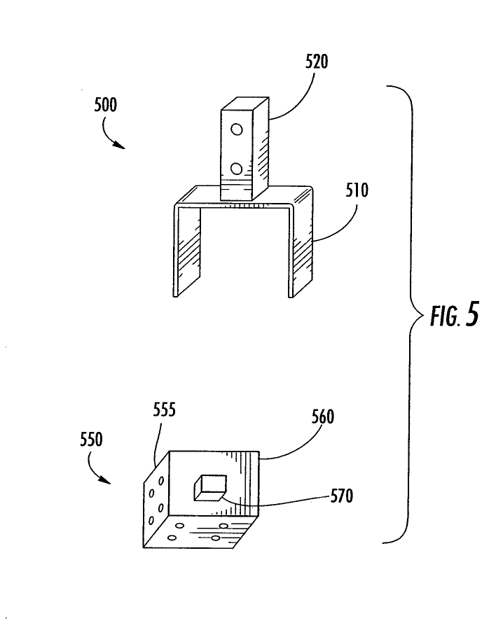

FIG. 5 illustrates a connector used in existing structures, such as wood-frame structures, where second (and subsequent) stories of a new structure can be built on top of the existing structure. As illustrated in FIG. 5, in one embodiment, connector 500 has a C-shaped plate 510 with a column receiving member 520 mounted on the plate. Connector 500 preferably comprises ⅛ inch steel plate 510 bended in a C shape, with a standard 2-½ inch by times 2-½ inch 12 gauge stanchion mount 520 welded to plate 510.

An alternative corner connector 550 is also illustrated in FIG. 5. Corner connector 550 preferably comprises an 8 inch by 16 inch plate 555 bended 90 degrees at center, with an 8 inch by 8 inch plate 560 welded on top. A standard 2-½ inch by 2-½ inch 12 gauge stanchion mount 570 is welded to the top of plate.

In a preferred embodiment, the new structure can be constructed without first removing the existing roof. Connectors 500, 550 are attached to the supporting beams after removing any interfering portions of the existing roof. Connector 500 is located in precise areas by laser inferometer or the like. Stanchion mounts 520, 570 facilitate placement of a three inch square tube that is slipped on and attached to a height sufficient to clear the existing roof. Stairwells and doorways may then be located and installed between the existing floor and the new floor. The existing roofline may be abandoned in place, or alternatively removed once the new floor is installed, greatly increasing the ceiling level of the existing floor. Subsequent floors may also be installed as permitted by engineering load calculations on the existing structure.

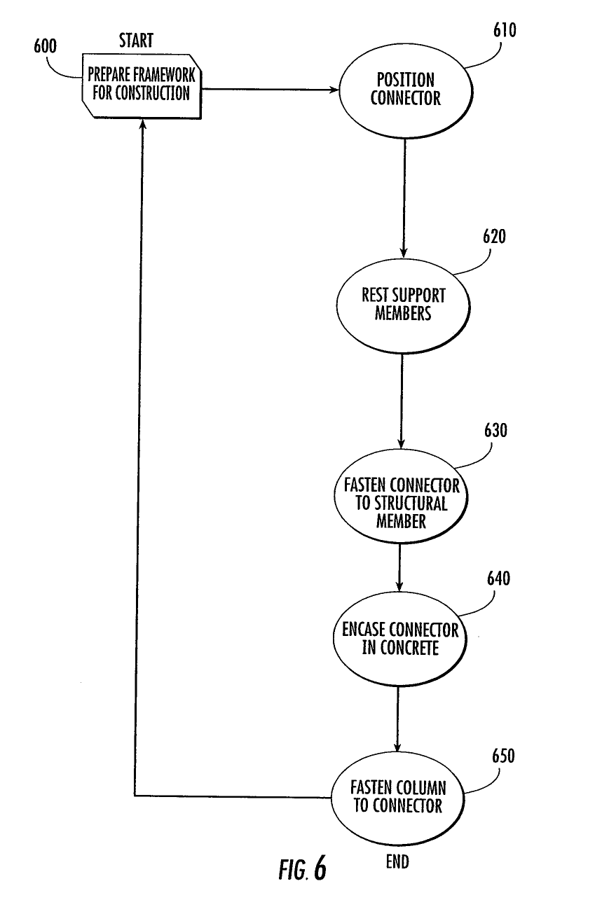

FIG. 6 is a flow chart that illustrates a method of constructing a multi-story structural framework for use in a building. In step 600, a framework is prepared for a new story. In a preferred embodiment, an existing structure is prepared by removing any interfering portions of the existing roof. Connector 500 has a C-shaped plate 510 with a column receiving member 520 mounted on the plate connector for existing structures where second (and subsequent) stories of the new structure can be built on top of existing structural members without removing the existing roof.

In step 610, a connector is precisely located for receiving column support member. For example, as shown in FIG. 3, a bottom connecting portion 210 of a connector 200 is positioned over and slid onto a column 305. In an alternate preferred embodiment, connector 500 is positioned onto a structural beam in an existing building.

In step 620, angle pieces 215 are fastened to the top of wall panel 340. Header tubing 350 is fastened above angle pieces 215 and the angle support member 215 of the connector structure 200 is rested on a wall panel. Angle pieces 215 help to transfer the load of the second and subsequent story poured concrete floors 280 to column support member 305 as illustrated in FIG. 3.

In step 630, the connector is fastened to a structural member. For example, apertures 241, 242, 243 and 244 in connector 200 and column 305 are aligned, and fasteners are inserted and secured. In an alternate preferred embodiment, connectors 500, 550 are fastened to existing structural beams.

In step 640, at least part of the bottom connecting portion 210 is encased in concrete 280. In a preferred method, described herein and illustrated in FIG. 3, epicor steel floor panels 360 are affixed to the header tubing 350. Batter boards are placed to locate the next floor of the structure, a concrete slab. Using this method, the position of each and every connector 200 is fixed in its precise and proper location before any concrete is poured. In another preferred embodiment, the concrete is poured to the height of a leveling plate 230.

In a preferred embodiment, the same concrete pour is used to form the slab (i.e., a monolithic pour) so that the level of the concrete comes up to leveling plates 230 of connectors 200. Because each connector 200 is resting on a column support member 305, the connectors 200 don't move during this process, allowing them to remain precisely located. The concrete is then allowed to set, thereby forming a concrete floor with 2) stanchions 222 already precisely located in the positions where the columns for the building framework of the next story are to be attached, and 3) a continuous steel connection running throughout perimeter of the foundation which connects each connector 200, and therefore each column, to each other. Alternatively, floor trusses may be installed to create the next floor.

After the connector 200 is encased in concrete 280 in step 640, the floor is set. After the floor is set, construction can continue with the next story. For example in step 650, upper level columns 270 are attached to the column receiving portion 220 of each connector 200.

Wall panels 340 comprising a frame and studs are then placed in between and attached to columns 305. In a preferred embodiment, the wall panels are prefabricated off-site. The wall panels 340 are affixed to columns 305 by attaching ¾ furring to the columns 305, and then securing the wall panels 340 to the furring using self-tapping screws.

Having thus described at least illustrative embodiments of the invention, various modifications and improvements will readily occur to those skilled in the art and are intended to be within the scope of the invention. Accordingly, the foregoing description is by way of example only and is not intended as limiting. The invention is limited only as defined in the following claims and the equivalents thereto.

What is claimed is:

1. A construction connector comprising:
an elongated main body having a longitudinal direction with two end portions; and
an angle support member attached to one end of the elongated main body, the angle support member having one arm extending transversely to the longitudinal direction of the elongated main body;

2. The construction connector of claim 1, further comprising a leveling plate attached transversely to the elongated main body.

3. The construction connector of claim 2, wherein the elongated main body defines at least one aperture at one end.

4. The construction connector of claim 3, wherein the angle support member is welded to the elongated main body.

5. The construction connector of claim 4, wherein the angle support member is at least ten gauge thick.

6. The construction connector of claim 5, wherein each end of the elongated main body is configured and adapted for attachment to a construction column.

7. The construction connector of claim 6, wherein the elongated main body has a rectangular cross-section.

8. The construction connector of claim 7, wherein the elongated main body has a square cross-section.

9. The construction connector of claim 8, wherein the connector is an integral member.

10. The construction connector of claim 9, wherein one end of the elongated main body is encased in concrete.

11. The construction connector of claim 10, wherein one end of the elongated main body is a stanchion over which a construction column may be placed.

12. The construction connector of claim 10, wherein one end of the elongated main body is a collar into which a construction column may be inserted.

13. A construction connector comprising:
an elongated main body having a longitudinal direction with two end portions, each end portion defining two apertures;
a leveling plate attached transversely to the elongated main body; and
an angle support member attached to one end of the elongated main body, the angle support member has two arms extending transversely to the longitudinal direction of the elongated main body;

14. A method of connecting multi-story structures for use in a building construction, comprising the steps of:
positioning a connector over a structural member;
fastening the connector to the structural member; and
fastening a column to the connector;

15. The method of claim 14, the method further comprising encasing at least part of the bottom connecting portion in concrete.

16. The method of claim 15, the method further comprising pouring concrete to a height of a leveling plate attached to the connector structure.

17. The method of claim 16, the method further comprising resting at least one angle support member of the connector structure on a wall panel.

18. The method of claim 17, the method further comprising sliding the connector over the column.

19. The method of claim 18, the method further comprising sliding the connector into the column.

20. The method of claim 19, the method further comprising locating the connector over an existing structural member using a laser inferometer.
